(19) United States
(12) Patent Application Publication
(10) Pub. No.: US 2014/0206835 A1
(43) Pub. Date: Jul. 24, 2014

(54) Hot Melt Composition

(71) Applicants: Seung Gweon Hong, Daejeon (KR); Min Ho Jeon, Daejeon (KR); Kwang Jin Chung, Daejeon (KR); Ki Nam Chung, Daejeon (KR); Myung Ahn Ok, Daejeon (KR); In Hun Son, Daejeon (KR)

(72) Inventors: Seung Gweon Hong, Daejeon (KR); Min Ho Jeon, Daejeon (KR); Kwang Jin Chung, Daejeon (KR); Ki Nam Chung, Daejeon (KR); Myung Ahn Ok, Daejeon (KR); In Hun Son, Daejeon (KR)

(73) Assignees: SK GLOBAL CHEMICAL CO., LTD., Seoul (KR); SK INNOVATION CO., LTD., Seoul (KR)

(21) Appl. No.: 14/238,988

(22) PCT Filed: Jul. 27, 2012
(86) PCT No.: PCT/KR2012/006030

§ 371 Date: Feb. 14, 2014

(30) Foreign Application Priority Data
Aug. 18, 2011 (KR) 10-2011-0081965

(51) Int. Cl. C09J 169/00

(52) U.S. Cl. CPC C09J 169/00
USPC 528/405

(57) ABSTRACT

Provided is a hot melt adhesive composition including aliphatic polycarbonate. With the hot melt adhesive composition according to the present invention, the pyrolysis temperature is low, such that the harmful gas is not generated at the time of waste treatment, resulting in providing an excellent environmentally friendly product. In addition, the hot melt adhesive composition has the low melting temperature to thereby be usable at low temperature and exhibit sufficient adhesive strength.

### TECHNICAL FIELD

The present invention relates to a hot melt adhesive composition including aliphatic carbonate, and more particularly, to a hot melt adhesive composition having a lower softening point and a low melt viscosity to thereby be applicable at a relatively low temperature, having excellent adhesion, and being environmentally friendly because toxic materials are not discharged at the time of disposal.

### BACKGROUND ART

Generally, a hot melt adhesive is a solid material at room temperature; however, when applying heat thereto, it is melted into a fluid state such as liquid or the like, to have adhesion to a material to be adhered. When the melted fluid state of hot melt adhesive is cooled, it is recovered to a solid state to have cohesion again. In addition, since the hot melted adhesive is made of a thermoplastic material, it is melted at high temperature to form a shape, which is then cooled to be rapidly adhered to the material. The hot melt adhesive mainly uses the Van der Waals force and a polarity combination on a surface thereof to adhere the adhesive and a material to be adhered to each other. The adhesive strength is influenced by an anchoring effect in which a liquid adhesive flows into a hole or an uneven portion to increase the adhesive strength. In order to perfectly use this effect, the hot melt adhesive needs to have enough flowability when being melted. For this, the hot melt adhesive needs to be melted at temperature as high as possible.

An ordinary hot melt adhesive of the related art mainly employs ethylenevinylacetate (EVA), which has been widely used for adhesion of a paperboard box, a construction interior material, or the like. The microwax included in the EVA serves to adjust melting viscosity.

The hot melt adhesive having the enough flowability and the high adhesive strength at a low melting temperature provides a high energy efficiency at the time of application and do not need to use a solvent according to the adhesive strength, which is an advantage of the hot melt, such that it is environmentally friendly. In addition, in the case in which a resin having pyrolysis temperature lower than that of the hot melt adhesive of the related art is used, a cost of treating waste after use may be decreased, which have economical and environmental benefits.

### DISCLOSURE OF INVENTION

### Technical Problem

An object of the present invention is to provide a hot melt adhesive capable of having high polarity to thereby improve adhesive strength to a paper, wood, a metal, or the like, and having a low pyrolysis temperature and not generating any harmful gas when combusted, to thereby lower energy consumption at the time of waste treatment and generate less air pollution, and thus be environmentally friendly.

### Solution to Problem

In one general aspect, the present invention provides a hot melt adhesive composition including aliphatic polycarbonate.

With the hot melt adhesive composition according to the present invention, pyrolysis temperature is low, such that harmful gas is not generated at the time of waste treatment, resulting in providing an excellent environmentally friendly product. In addition, the hot melt adhesive composition has a low melting temperature to thereby be usable at a low temperature and exhibit sufficient adhesive strength.

Hereinafter, the present invention will be described in detail.

The present invention provides a hot melt adhesive composition including the aliphatic polycarbonate, and the aliphatic polycarbonate is obtained by reacting carbon dioxide and at least one different epoxide compound.

The epoxide compound are at least one selected from the group consisting of
(C2-C10)alkylene oxide substituted or unsubstituted with halogen or alkoxy;
(C4-C20)cycloalkyleneoxide substituted or unsubstituted with halogen or alkoxy; and
(C8-C20)styreneoxide substituted or unsubstituted with halogen, alkoxy, alkyl, or aryl.

Specific examples of the alkoxy may include alkyloxy, aryloxy, aralkyloxy, and the like, and examples of the aryloxy may include phenoxy, biphenyloxy, naphthyloxy, and the like. The alkoxy, alkyl, and aryl may have a substituent selected from a halogen atom or an alkoxy group.

More specifically, the aliphatic polycarbonate may be represented by Chemical Formula 1 below:

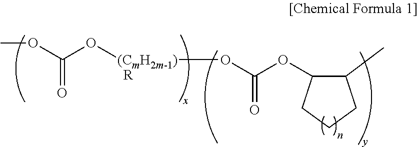

[in Chemical Formula 1, m is an integer of 2 to 10; n is an integer of 1 to 3; R is hydrogen, (C1-C4)alkyl, or -CH₂-O-R′ (R′ is (C1-C8)alkyl); and x:y is 5:95 to 99.99:0.01].

Specific examples of the epoxide compound according to the present invention may include ethylene oxide, propylene oxide, butene oxide, pentene oxide, hexene oxide, octene oxide, decene oxide, dodecene oxide, tetradecene oxide, hexadecene oxide, octadecene oxide, butadiene monoxide, 1,2-epoxide-7-octene, epifluorohydrine, epichlorohydrine, epibromohydrine, isopropyl glycidyl ether, butyl glycidyl ether, t-butyl glycidyl ether, 2-ethylhexyl glycidyl ether, allyl glycidyl ether, cyclopentene oxide, cyclohexene oxide, cyclooctene oxide, cyclododecene oxide, alpha-pinene oxide, 2,3-epoxidenorbornene, limonene oxide, dieldrin, 2,3-epoxidepropylbenzene, styrene oxide, phenylpropylene oxide, stilbene oxide, chlorostilbene oxide, dichlorostilbene oxide, 1,2-epoxy-3-phenoxypropane, benzyloxymethyl oxirane, glycidyl-methylphenyl ether, chlorophenyl-2,3-epoxidepropyl ether, epoxypropyl methoxyphenyl ether, biphenyl glycidyl ether, glycidyl naphthyl ether, and the like.

An example of a method of producing the aliphatic polycarbonate may include a solution polymerization method or a bulk polymerization method. More specifically, polymerization may be performed by feeding carbon dioxide in the presence of the epoxide compound and a catalyst while using an organic solvent as a reactive medium.

As the organic solvent, aliphatic hydrocarbons such as pentane, octane, decane, cy-clohexane, and the like; aromatic hydrocarbons such as benzene, toluene, xylene, and the like; and halogenated hydrocarbons such as chloromethane, methylenechloride, chloroform, carbontetrachloride, 1,1-dichloroethane, 1,2-dichloethane, ethylchloride, trichloroethane, 1-chloropropane, 2-chloropropane, 1-chlorobutane, 2-chlorobutane, 1-chloro-2-methylpropane, chlorobenzene, bromobenzene, and the like, may be used alone or in combination of two or more thereof. The pressure of carbon dioxide may be from normal pressure to 100 atm, and preferably, 5 atm to 30 atm. The polymerization temperature at the time of copolymerization may be 20˜120° C., and preferably, 50˜90° C. More preferably, the bulk polymerization method using a monomer itself as a solvent may be performed.

The aliphatic polycarbonate is polyalkylene carbonate produced based on descriptions of Korean Patent Laid-Open Publication Nos. 2008-0015454, 2009-0090154, 2010-067593, and 2010-0013255 filed by the present applicants, and examples of the alkylene may include, but are not limited to, ethylene, propylene, 1-butylene, cyclohexene, alkylglycidylether, n-butyl, n-octyl, and the like.

In the present invention, the aliphatic polycarbonate of Chemical Formula 1 above leads to a hot melt adhesive composition having a glass transition temperature (Tg) of 40 to 110° C.

The hot melt adhesive composition according to the present invention has a softening point of 70 to 130° C. Hence, the hot melt adhesive composition according to the present invention has an excellent adhesive strength or viscosity despite the low softening point thereof, and thus, is favorably applied at a low temperature.

In the present invention, the residual amount of a catalyst in the aliphatic poly-carbonate used in the hot melt adhesive composition is 3 ppm or less. The residual amount of catalyst is minimized, such that the hot melt adhesive composition may be anticipated to have improved adhesive strength and thermal stability.

### Advantageous Effects of Invention

With the hot melt adhesive composition according to the present invention, the pyrolysis temperature is low, such that the harmful gas is not generated at the time of waste treatment, resulting in providing an excellent environmentally friendly product. In addition, the hot melt adhesive composition has the low melting temperature to thereby be usable at low temperature and exhibit sufficient adhesive strength. In addition, the hot melt adhesive composition is not easily pyrolyzed when being exposed to heat, due to the low residual amount of catalyst of 3 ppm or less.

### BEST MODE FOR CARRYING OUT THE INVENTION

Hereinafter, the present invention will be described in detail with reference to the examples, but is not limited to the following examples.

### Example 1

Polypropylene carbonate having molecular weight of 290,000 g/mol as a base resin was extruded by using a 5 m-length twin extruder at a rate of 1.6 kg/h at 230° C. to obtain polypropylene carbonate having a molecular weight of 50,000 g/mol. Next, the low-molecular weight polypropylene carbonate and 10 parts by weight of propylene carbonate as a plasticizer were mixed together, and the mixture was then extruded by using a twin extruder at 190° C., to be produced into a pellet. The viscosity of the thus produced hot melt adhesive was 10 Pa·sec. The hot melt adhesive was melted at 190° C., and then applied between a PVC sheet and wood in order to adhere them. The adhesive strength measurement result is shown in Table 1 below.

### Example 2

10 parts by weight of propylene carbonate, and 5 parts by weight carnauba wax as a plasticizer were mixed to the polypropylene carbonate having a molecular weight of 50,000 g/mol, produced according to the same method as Example 1 above, and was extruded by using twin extruder at 190° C., to be produced into a pellet. The viscosity of the thus produced hot melt adhesive was 5 Pa·sec at 180° C. The hot melt adhesive was melted at 190° C., and then applied between a PVC sheet and wood in order to adhere them. The adhesive strength measurement result is shown in Table 1 below.

### Comparative Example 1

40 g of rosin ester having a softening point of 90° C., 20 g of a paraffin wax having a melting point of 60° C. were mixed to 40 g of Ethylene vinylacetate having a vinyl acetate content of 20%, thereby producing a hot melt adhesive. The viscosity of the thus produced hot melt adhesive was 10 Pa·sec. The hot melt adhesive was melted at 190° C., and then applied between a PVC sheet and wood in order to adhere them. The adhesive strength measurement result is shown in Table 1 below.

TABLE 1
Result of Measuring Physical Properties

| | Viscosity | Adhesion | Softening |
|---|---|---|---|
| | (Pa · s) | (kgf) | Point (° C.) |
| Example 1 | 10 | 44 | 110 |
| Example 2 | 5 | 38 | 100 |
| Comparative | 10 | 40 | 130 |
| Example 1 | | | |

As shown in FIG. 1 above, it may be appreciated that the hot melt adhesive compositions according to Examples 1 and 2 of the present invention had softening points of 100° C. and 110° C., respectively, and thus, the low melting temperatures thereof were low, such that they were usable at a low temperature and exhibited sufficient adhesive strength. The hot melt adhesive composition according to the present invention can have a softening point lower than that of Comparative Example 1 and unreduced adhesive strength, thereby providing an environmentally friendly hot melt adhesive.

1. A hot melt adhesive composition comprising aliphatic polycarbonate.

2. The hot melt adhesive composition of claim 1, wherein the aliphatic polycarbonate is obtained by reacting carbon dioxide and at least one different epoxide compound.

3. The hot melt adhesive composition of claim 2, wherein the epoxide compound is at least one selected from the group consisting of (C2-C10)alkylene oxide substituted or unsubstituted with halogen or alkoxy; (C4-C20)cycloalkyleneoxide substituted or unsubstituted with halogen or alkoxy; and (C8-C20)styreneoxide substituted or unsubstituted with halogen, alkoxy, alkyl, or aryl.

4. The hot melt adhesive composition of claim 1, wherein the aliphatic polycarbonate is represented by Chemical Formula 1 below: 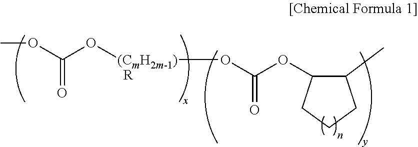
[in Chemical Formula 1, m is an integer of 2 to 10; n is an integer of 1 to 3; R is hydrogen, (C1-C4)alkyl, or —CH2—O—R′ (R′ is (C1-C8)alkyl); and x:y is 5:95 to 99.99:0.01.)].

5. The hot melt adhesive composition of claim 2, wherein the aliphatic polycarbonate has a molecular weight of 50,000 g/mole, which is controlled by using a twin extruder at a rate of 1.0-2.0kg/h at 225˜240° C., the twin extruder having an extruding path length of 4 to 6 M.

6. The hot melt adhesive composition of claim 4, wherein the aliphatic polycarbonate has a glass transition temperature (Tg) of 40 to 110° C.

7. The hot melt adhesive composition of any one of claim 1, wherein it has a softening point of 70 to 130° C.

8. The hot melt adhesive composition of claim 7, wherein a residual amount of catalyst in the aliphatic polycarbonate is 3 ppm or less.

9. The hot melt adhesive composition of claim 2, wherein the aliphatic polycarbonate is represented by Chemical Formula 1 below: 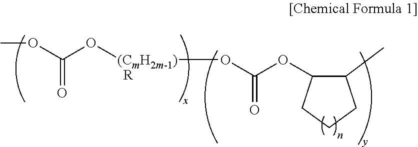
[in Chemical Formula 1, m is an integer of 2 to 10; n is an integer of 1 to 3; R is hydrogen, (C1-C4)alkyl, or —CH2—O—R′ (R′ is (C1-C8)alkyl); and x:y is 5:95 to 99.99 :0.01.)].

10. The hot melt adhesive composition of claim 9, wherein the aliphatic polycarbonate has a glass transition temperature (Tg) of 40 to 110° C.

11. The hot melt adhesive composition of claim 2, wherein it has a softening point of 70 to 130° C.

12. The hot melt adhesive composition of claim 3, wherein it has a softening point of 70 to 130° C.

13. The hot melt adhesive composition of claim 4, wherein it has a softening point of 70 to 130° C.

14. The hot melt adhesive composition of claim 5, wherein it has a softening point of 70 to 130° C.

15. The hot melt adhesive composition of claim 6, wherein it has a softening point of 70 to 130° C.

16. The hot melt adhesive composition of claim 9, wherein it has a softening point of 70 to 130° C.

17. The hot melt adhesive composition of claim 10, wherein it has a softening point of 70 to 130° C.

18. The hot melt adhesive composition of claim 11, wherein a residual amount of catalyst in the aliphatic polycarbonate is 3 ppm or less.

19. The hot melt adhesive composition of claim 12, wherein a residual amount of catalyst in the aliphatic polycarbonate is 3 ppm or less.

20. The hot melt adhesive composition of claim 13, wherein a residual amount of catalyst in the aliphatic polycarbonate is 3 ppm or less.
